(19) United States
(12) Patent Application Publication
(10) Pub. No.: US 2005/0096786 A1
(43) Pub. Date: May 5, 2005

(54) Tablet dispensing packing apparatus

(75) Inventor: Jun-ho Kim, Dalseo-Gu (KR)

Correspondence Address: OBLON, SPIVAK, MCCLELLAND, MAIER & NEUSTADT, P.C., 1940 DUKE STREET, ALEXANDRIA, VA, 22314, US

(73) Assignee: JVM CO., LTD., Daegu (KR)

(21) Appl. No.: 10/942,922

(22) Filed: Sep. 17, 2004

(30) Foreign Application Priority Data
Sep. 18, 2003 (KR) 2003-64825

(51) Int. Cl. B65B 61/26; G06F 17/00

(52) U.S. Cl. 700/242

(57) ABSTRACT

Disclosed is an output control apparatus of an actuation means for tablet dispensing and packing of a tablet dispensing and packing apparatus, and more particularly to a processing unit setting system for tablet packing, which is capable of controlling a heating roller, open/close time of a hopper, printing position, cutting time of a cutter, tablet dropping time into an auxiliary tray, operation time of a tablet cassette, etc., using digital signals, and easily effecting setting (initializing operation) of output control signals by an operator. The tablet dispensing and packing apparatus enables simple initialization or adjustment of set values of an encoder controller from outside of the tablet dispensing and packing apparatus to provide convenience to the operator, using an operation control unit contained within a body of the tablet dispensing and packing apparatus and including an external monitor and a user input keypad of the tablet dispensing and packing apparatus, or a sever computer for controlling the tablet dispensing and packing apparatus.

### BACKGROUND OF THE INVENTION

1. Field of the Invention

The present invention relates to an output control apparatus of an actuation means for tablet dispensing and packing of a tablet dispensing and packing apparatus, and more particularly to a processing unit setting system for tablet packing, which is capable of controlling a heating roller, open/close time of a hopper, printing position, cutting time of a cutter, tablet dropping time into an auxiliary tray, operation time of a tablet cassette, etc., using digital signals, and easily effecting setting (initializing operation) of output control signals by an operator.

2. Description of the Related Art

A tablet dispensing and packing apparatus is an apparatus which automatically performs discharge and collection of tablets to pack and discharge collected tablets for each dose when prescription by doctors or pharmacists in hospitals or pharmacies is inputted to computers. This apparatus includes a plurality of tablet cassettes containing various kinds of tablets and arranged on tablet storage shelves. The plurality of tablet cassettes arranged on the tablet storage shelves are intermittently controlled such that tablets prescribed dose by dose are discharged to a hopper at a lower side of the tablet storage shelves through respective passages formed in the tablet storage shelves. Then, the discharged tablets collected in the hopper are discharged to a lower side of the hopper and packed by packing papers.

In addition, the tablet dispensing and packing apparatus may further include an auxiliary tray into which medicine not contained in the tablet cassettes is manually put.

With the tablet dispensing and packing apparatus constructed as above, a leading end of a packing paper roll on which a packing paper is rolled is moved to fold the packing paper, and the tablets collected in the hopper are injected into the folded packing papers by open/close operation of an outlet of the hopper.

The packing paper is successively folded and then introduced between a pair of heating rollers, a crosswise junction portion is formed while applying heat from the heating roller to both edges of the packing paper, a lengthwise junction portion is formed with a constant interval according to the dosage amount, and an dotted cutting line is formed in the lengthwise junction portion using a cutter in order to complete the packing operation.

On the other hand, the tablet dispensing and packing apparatus prints patient name, dosage time, etc., using a printer before the packing paper is folded.

In order to share and pack the tablets, components including the tablet cassettes, the heating roller, the open/closure of the hopper, the printer, the auxiliary, the cutter, etc. are interconnected and actuated by respective actuating means which are controlled at an optimal point of time.

FIG. 1 is a view illustrating an apparatus for outputting signals for operation time of conventional actuation means to a main controller of a tablet dispensing and packing apparatus.

In order to output signals for the operation time of the tablet cassettes, the operation time of the heating roller, the open/close time of the hopper, the print time of the printer, and the medicine injection time, into the auxiliary tray, and the operation time of the cutter, a main axis 102 rotated by a main motor 101 rotates the heating roller while opening/closing an open/close valve of the hopper. In addition, in order to set the operation time of the actuation means to be controlled, a plurality of disc-like magnet loaders 103 having magnets 103a installed at their circumferences are provided and a hole sensor 104 for sensing the magnets 103a is provided at a position corresponding to each of the plurality of disc-like magnet loaders 103.

Accordingly, the main controller 105 receives signals of the magnets 103a sensed by the hole sensor 104 according to rotation of the plurality of disc-like magnet loaders 103 and controls the components such as the main motor 101, the cutter 106, the printer 107, the auxiliary tray 108, and the tablet cassettes.

In other words, the main controller 105 opens the open/close valve of the hopper at a point of time when the heating roller is temporarily stopped after rotation by the main motor 101, and actuates the plurality of tablet cassettes and the auxiliary tray 108 at a moment that the open/close valve of the hopper is closed, such that the tablets are dropped into and collected in the hopper. Such an operation is repeated.

In addition, the main controller 105 controls the printer 107 to print patient name, dosage time, etc., on a center of the packing paper packed for each dose by the heating roller and controls the cutter 106 to cut the lengthwise junction portion precisely.

In the course of this control of automatically dispensing and packing the tablets, if it is necessary to adjust the control of the heating roller, the open/close time of the hopper, the print position, the cutting time of the cutter, the medicine injection time into the auxiliary tray, the operation time of the tablet cassettes, etc., then a distance between the hole sensors and the magnets is reset (or initialized) by adjusting positions of the magnets provided in the plurality of disc-like magnet loaders.

Since it is difficult to adjust the magnets provided in the plurality of disc-like magnet loaders to proper positions, it takes much time and also is difficult for unskilled workers to perform such an adjustment.

In addition, since the disc-like magnet loaders provided on the main axis may not be maintained in a fixed state due to the operation of the tablet dispensing and packing apparatus, malfunction of the apparatus is apt to occur. Also, since reset of positions of the disc-like magnet loaders suffers from the difficulty mentioned as above, packing efficiency of the tablets may be deteriorated.

To overcome the difficulty as mentioned above, an actuator output control apparatus using an encoder has been conventionally suggested which converts a main axis rotation angle of the main motor into digital signals using the encoder so that the main controller can control respective actuators, based on the digital signals, at positions predetermined by an operator.

In such an actuator output control apparatus, the encoder is provided in an end of the main axis of the main motor to extract a rotation angle of the main motor. In addition, the actuator output control apparatus further includes an encoder controller for outputting command signals to the main controller according to on values predetermined by the operator based on the rotation angle extracted by the encoder.

The actuator output control apparatus of the tablet dispensing and packing apparatus using such a conventional encoder controls the actuation means for dispensing and packing according to the rotation angle of the main axis of the main motor and provides output signals, which are detected by the encoder provided on the end of the main axis of the main motor according to the rotation of the main motor, for the encoder controller.

The encoder controller calculates the rotation angle of the main motor based on the output signals of the encoder and outputs a signal to the main controller at a corresponding rotation angle according to a value predetermined in the encoder controller.

The main controller receives the signal outputted from the encoder controller and actuates a corresponding actuation means based on the received signal.

Herein, the value predetermined in the encoder controller is initially set at the time of product shipment and thereafter the operator can reset (adjust) the operation time of each component of the tablet dispensing and packing apparatus through the encoder controller.

The encoder controller outputs a control signal to the main controller based on the reset operation time.

The tablet dispensing and packing apparatus using such an encoder has to adjust the set values of the encoder controller if errors occur in the tablet dispensing and packing apparatus, such as jostle of the packing paper or deviation from an original cutting position of the packing paper and an original position of the lengthwise portion.

In order to adjust the set values of the encoder controller, a body case of the tablet dispensing and packing apparatus is opened to expose the encoder controller therein and a set value at which the error occurs is adjusted by means of a user-set value adjustment means contained in the encoder controller.

The user-set value adjustment means is in the form of a key panel for inputting user-set values, which is referred to as a positioner. The operator inputs a code stored for each user-set value and then readjusts a preset value by inputting a value corresponding to the input code.

As described above, in the actuator output control apparatus of the tablet dispensing and packing apparatus using such an encoder the tablet dispensing and packing apparatus has to be opened by the operator, which is an inconvenience to the operator, in order to input an adjustment value through a user input means of the encoder controller if adjustment of the user-set values is required.

In addition, when the user-set values are inputted, since the operator has to input an adjustment value set for each item consisting of simple numerical codes through a user input interface, it is not easy for the operator to input the adjustment value.

### SUMMARY OF THE INVENTION

Therefore, it is an object of the present invention to provide a tablet dispensing and packing apparatus, which enables simple initialization or adjustment of set values of an encoder controller from outside of the tablet dispensing and packing apparatus to provide convenience to the operator, using an operation control unit contained within a body of the tablet dispensing and packing apparatus and including an external monitor and a user input keypad of the tablet dispensing and packing apparatus, or a sever computer for controlling the tablet dispensing and packing apparatus.

In accordance with an aspect of the present invention, the above and other objects can be accomplished by the provision of a tablet dispensing and packing apparatus including an actuation means operation control unit for each of the components for controlling dispensing and packing operation for tablets loaded in tablet cassettes, wherein the actuation means operation control unit comprises an encoder for detecting rotation of a main motor, an encoder control means for calculating a rotation angle based on the detected rotation and comparing the calculated rotation angle with a value set by a user to determine operation time of each of the components, and a user interface means for setting the user set value within the encoder control means according to a predetermined program.

Preferably, the user interface means includes a program execution means for executing a program for setting the user set value, a display means for displaying a picture provided by the program for setting the user set value, and a key input means for inputting the user set value.

Preferably, the user interface means is provided outside the tablet dispensing and packing apparatus and comprises an operation control unit contained within a body of the tablet dispensing and packing apparatus and including an external monitor and a user input keypad of the tablet dispensing and packing apparatus, or a sever computer for controlling the tablet dispensing and packing apparatus.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a view illustrating configuration of actuation means control devices for tablet dispensing and packing in a conventional tablet dispensing and packing apparatus;

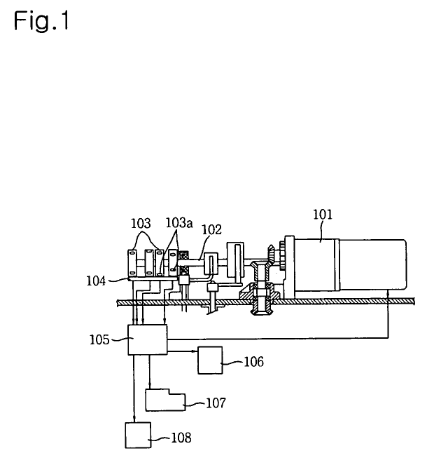

FIG. 2 is a view illustrating configuration of actuation means control devices for tablet dispensing and packing in a tablet dispensing and packing apparatus according to the present invention;

FIG. 3 is a perspective view illustrating a processing unit setting system of a tablet dispensing and packing apparatus according to the present invention;

FIG. 4 is a flow chart showing a procedure for resetting (adjusting) user-set values according to the present invention;

FIG. 5 is a view illustrating an example of password input display screen for adjustment of the user-set values according to the present invention;

FIG. 6 is a view illustrating an example of user-set value (rotation angle) display screen according to the present invention;

FIG. 7 is a view illustrating an example of user-set value (delay) display screen according to the present invention; and

FIG. 8 is a view illustrating an example of user-set value (motor rotation speed and communication port) display screen according to the present invention.

### DESCRIPTION OF THE PREFERRED EMBODIMENTS

Hereinafter, a preferred embodiment of the present invention will be described with reference to the accompanying drawings.

An encoder 2 for detecting signals according to the rotation of a main motor 1 is provided on a main axis la of the main motor 1.

An encoder controller 4 is provided to calculate the rotation angle of the main motor 1 with an output signal of the encoder 2 as an input, compare the calculated rotation angle with a user-set angle set within the encoder controller 4, and output signals indicating operation time of actuation means to a main controller 3.

The main controller 3 controls the main motor 1, a cutter 5, a printer 6, an auxiliary tray 7, etc., based on the signals transmitted from the encoder controller 4, and controls a series of procedures for tablet dispensing and packing, such as printing of a packing paper, packing of tablets and forming of a cutting line.

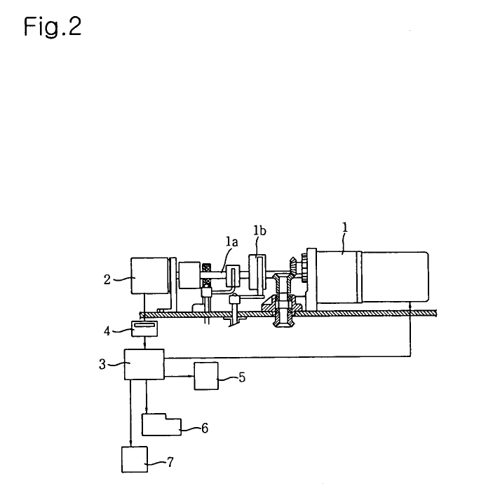

In FIG. 2, reference numeral 1b denotes a cam for opening/closing an open/close valve of a hopper.

In addition, a server computer 8 for controlling the tablet dispensing and packing apparatus is provided as a user interface means for resetting (adjusting) a user-set value (rotation value) set within the encoder controller 4. The server computer 4 incorporates a user-set value adjustment program for setting the user-set value (rotation value) for determining operation time of each actuation means in the encoder controller 4.

With the present invention constructed as above, when the rotation angle of the main motor is detected and the actuation means of each components for dispensing and packing the tablets based on the detected rotation angle is controlled, the rotation angle of the main motor for determining the operation time of the actuation means of each component for dispensing and packing the tablets can be simply set from the outside of the tablet dispensing and packing apparatus.

In addition, as described above, the server computer 8 for controlling the tablet dispensing and packing apparatus incorporates a program for setting the rotation angle of the main motor 1 for determining the operation time of the actuation means of each component of the tablet dispensing and packing apparatus.

The program provides a graphic user interface (GUI) to be displayed on a screen to allow an operator to easily adjust the user-set value (rotation angle) set in the encoder controller 4.

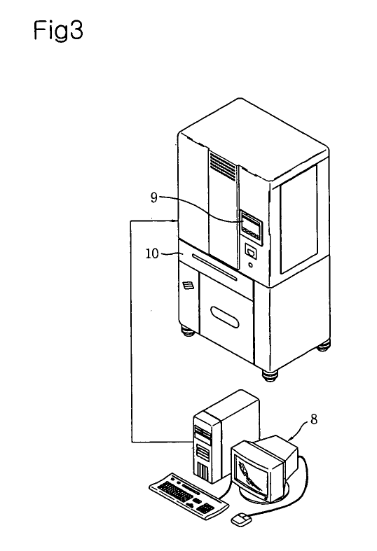

Such a program can be loaded into an operation control unit contained within a body of the tablet dispensing and packing apparatus. The operator can adjust the user-set value using a monitor (9 in FIG. 3), a keyboard, etc., exposed to the outside of the tablet dispensing and packing apparatus.

In this case, the monitor 9 can include a touch panel as a user input means together with a display screen provided from the program.

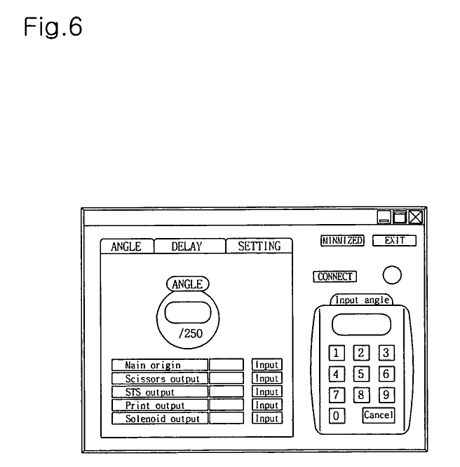

The user-set value (rotation angle) set using the program is a rotation angle of the main motor 1 for determining control time of the heating roller, open/close time of the hopper (main origin in FIG. 6), operation time of the cutter (scissors output in FIG. 6), medicine injection time of the auxiliary tray 10 (STC output in FIG. 6), print starting time (print output in FIG. 6), and open time of the open/close valve of the hopper (solenoid output in FIG. 6).

The user-set value for determining the operation time of each component for automatically dispensing and packing the tablets is stored in the encoder controller 4 and is initially set at the time of product shipment.

The encoder controller 4 compares a stored rotation angle with the rotation angle of the main motor 1 detected by the encoder 2 and determines operation time of the main controller 3.

The encoder controller 4 comprises a programmable logic controller (PLC).

Next, the operation of the tablet dispensing and packing apparatus of the present invention, constructed as above, will be described in detail.

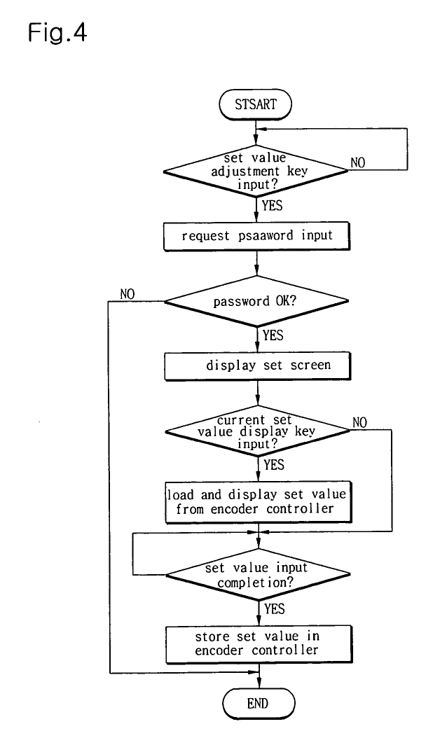

FIG. 4 is a flow chart showing a procedure for resetting (adjusting) user-set values by an operator.

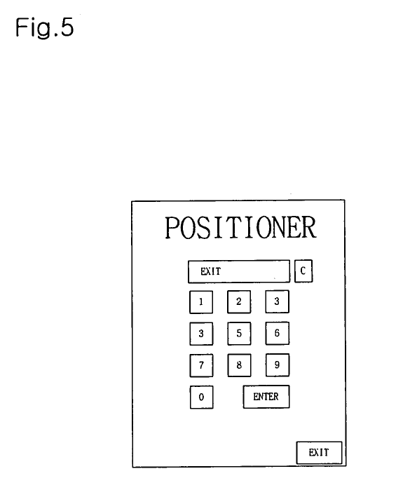

When the operator selects a set value adjustment menu on the screen of the server computer 8, a screen for input of a password for certifying authority on the adjustment of the set values is displayed, as shown in FIG. 5.

The operator inputs the password in the screen, and if the password inputted by the operator is correct, then a user-set value adjustment screen is displayed as shown in FIG. 6.

When the operator selects an initial value display menu (connect in FIG. 6) from the user-set value adjustment screen, the server computer 8 reads a user-set value currently set from the encoder controller 4 and displays the read value on the screen.

The operator confirms the displayed set value and then inputs a desired value in an item to be adjusted to complete the adjustment operation.

For example, if a printing position of the packing paper is jostled, the printing position can be adjusted by inputting an adjustment value before and after a previously displayed set value.

In the tablet dispensing and packing apparatus of the present invention, the user-set value includes not only the rotation angle of the main motor, as described above, but also delay time of signals, rotation speed of the main motor, and establishment of communication port with the PLC (encoder controller) so that signals for controlling the operation of the actuation means can be reliably perceived.

FIGS. 6 to 8 shows embodiments of a user-adjustment value display (GUI). As shown in the figures, various kinds of GUIs can be implemented, and desired adjustment values can be inputted using various kinds of input interfaces, such as a mouse, a keyboard or a touch panel.

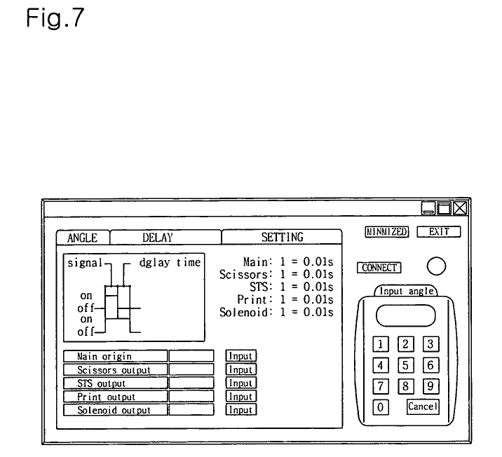

FIG. 7 shows an embodiment of a delay value set screen in a displayed user setting screen.

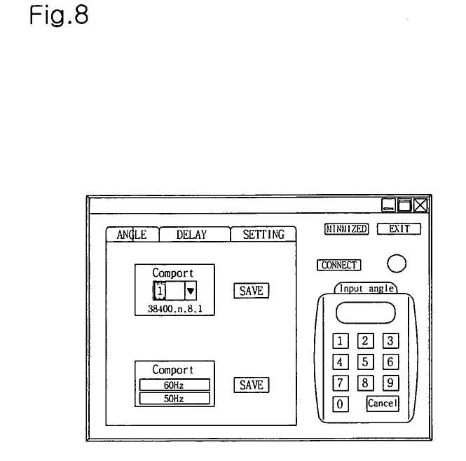

FIG. 8 shows an embodiment of a motor rotation speed and communication port establishment screen in a displayed user setting screen.

The inputted adjustment values as the user-set values are sent to and stored in the encoder controller 4. Thereafter, using these adjustment values, the encoder controller 4 provides operation control values of each actuation means for the main controller 3.

As is apparent from the above description, with a tablet dispensing and packing apparatus of the present invention, if errors occur in the tablet dispensing and packing apparatus, such as shoving of the packing paper, shoving of the printing position or shoving of the cutting line position, an operator can adjust the apparatus to a normal state by simply changing preset values through an external user interface.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A tablet dispensing and packing apparatus including an actuation means operation control unit for each of the components for controlling dispensing and packing operation for tablets loaded in tablet cassettes, wherein the actuation means operation control unit comprises:
an encoder for detecting rotation of a main motor;
an encoder control means for calculating a rotation angle based on the detected rotation and comparing the calculated rotation angle with a value set by a user to determine operation time of each of the components; and
a user interface means for setting the user-set value within the encoder control means contained within a body of the apparatus, according to a predetermined program,
wherein the user interface means includes a program execution means for executing a program for setting the user-set value, a display means for displaying a screen provided by the program for setting the user-set value, and an input means for inputting the user set value.

2. The tablet dispensing and packing apparatus as set forth in claim 1, wherein the user interface means comprises an operation control means contained within a body of the apparatus and including an external monitor and a keyboard of the apparatus.

3. The tablet dispensing and packing apparatus as set forth in claim 2, wherein the operation control means comprises a touch panel.

4. The tablet dispensing and packing apparatus as set forth in claim 1, wherein the user interface means comprises a sever computer for controlling the apparatus.

5. The tablet dispensing and packing apparatus as set forth in claim 1, wherein the user-set value set by the user interface means further includes delay time of a control signal.

6. The tablet dispensing and packing apparatus as set forth in claim 1, wherein the user-set value set by the user interface means further includes a rotation speed of a motor.

7. The tablet dispensing and packing apparatus as set forth in claim 1, wherein the user-set value set by the user interface means further includes establishment of communication port with the encoder control means.

8. The tablet dispensing and packing apparatus as set forth in any one of claims 1 to 7, wherein the program for setting the user-set value provides a user-set value setting function including a step of requesting a password for a set value key input request from an operator, a step of inputting a correct password of the operator, displaying a set value input screen, and loading a set value for each item set currently out of the encoder control means according to a request from the operator, and a step of storing the set value inputted by the operator through the set value input screen in the encoder control means as the user-set value.
